(19) United States
(12) Patent Application Publication
(10) Pub. No.: US 2026/0263988 A1
(43) Pub. Date: Sep. 10, 2026

(54) System and Method for Separating Carbon Dioxide from the Ambient Air

(71) Applicant: Volkswagen AKtiengesellschaft, Wolfsburg (DE)

(72) Inventors: Enrica Lange, Calberlah (DE); Christine Schütz, Vordorf (DE); Christian Heimermann, Wolfsburg (DE)

(73) Assignee: Volkswagen AKtiengesellschaft, Wolfsburg (DE)

(21) Appl. No.: 19/165,330

(22) PCT Filed: Mar. 14, 2024
(86) PCT No.: PCT/EP2024/056839

§ 371 Date: Sep. 15, 2025

(30) Foreign Application Priority Data
Mar. 23, 2023 (DE) 10 2023 202 651.1

(51) Int. Cl. B01D 53/12; B01D 53/26; B01D 53/28

(52) U.S. Cl. CPC B01D 53/12; B01D 53/261; B01D 53/28; B01D 2257/504; B01D 2257/80; B01D 2258/06; B01D 2259/40088

(57) ABSTRACT

The disclosure relates to a system for separating carbon dioxide from the ambient air. The system comprises a dehumidification unit for dehumidifying a gas flow of ambient air and a carbon dioxide separation unit connected downstream of the dehumidification unit in the direction of flow of a gas flow through the system. The carbon dioxide separation unit has an adsorption chamber and a desorption chamber that is different from the adsorption chamber. A sorbent is arranged in the carbon dioxide separation unit. The carbon dioxide separation unit comprises a transport means with which the sorbent can be transported from the adsorption chamber into the desorption chamber after absorbing carbon dioxide from a gas flow dried by the dehumidification unit and/or from the desorption chamber into the adsorption chamber after desorption of the carbon dioxide from the sorbent.

### CROSS-REFERENCE TO RELATED APPLICATIONS

This application claims priority to German Patent Application DE 10 2023 202 651.1, filed on Mar. 23, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a system for separating carbon dioxide from the ambient air and to a method for separating carbon dioxide from the ambient air using such a system according to the preamble of the independent claims.

The need to slow down global climate change, which is being accelerated by greenhouse gas emissions, is very urgent. Above all, the increase in atmospheric carbon dioxide levels must be sustainably reduced. In order to reduce the carbon dioxide content in the ambient air and achieve climate neutrality, not only must carbon dioxide emissions be reduced, unavoidable carbon dioxide emissions must also be offset accordingly. A known method for separating carbon dioxide from the ambient air is the so-called “direct air capture (DAC) method,” in which ambient air is conducted through an adsorption chamber and the carbon dioxide contained in the ambient air is at least partially separated from the ambient air. Such methods are suitable for reducing the carbon dioxide content of the atmosphere and thus counteracting climate change. To do so, the development of powerful and efficient processes to remove carbon dioxide from the atmosphere is essential. One option is to use a sorbent material to capture carbon dioxide. The carbon dioxide is chemically and/or physically bound and subsequently released from the sorbent material by heating and lowering the pressure level in order to concentrate the released carbon dioxide and supply it to an intermediate storage tank or a subsequent process step that requires carbon dioxide as a starting material.

Among other things, systems, also known as direct air capture systems, with stationary sorbent material are used to separate carbon dioxide from industrial plants and from the ambient air. The sorbent material can be spherical or pellet-shaped and is usually a few millimeters in size. The sorbent is available as loose fill. The ambient air or industrial waste gases are conducted over this loose sorbent bed and the sorbent separates CO₂ from the gas flow. The binding of carbon dioxide (CO₂) to the sorbent is reversible. If the sorbent material used is sensitive to moisture, the gas flow must first be dehumidified. For this purpose, a dehumidification stage is installed upstream of the carbon dioxide separation stage. This is a stationary bed with a solid drying means that can specifically bind water reversibly. The drying means is usually spherical and a few millimeters in size. If the drying means is so saturated that water is no longer fully absorbed, the drying means is regenerated. To do this, the drying means is dried at a high temperature until the water is completely released from the drying means. The drying means is thus regenerated and is available for repeated water absorption. Following the regeneration of the drying means, the dry gas flow is conducted through a fixed bed of sorbent material that can specifically bind carbon dioxide or through structured packings that can bind carbon dioxide. The sorbent reversibly binds carbon dioxide and the outgoing gas flow is substantially free of carbon dioxide.

Once the sorbent has reached CO₂ saturation, it is subjected to a high temperature and to negative pressure or a vacuum until the carbon dioxide is completely released from the sorbent (desorption). The sorbent is thus regenerated and is available for repeated absorption of carbon dioxide. The removed carbon dioxide is compressed and collected in a separate device, such as a gas cylinder. The desorbed carbon dioxide is highly concentrated and can be used as synthesis gas, for example.

The disadvantages of these processes are the alternating heating and cooling processes in the stationary sorbent beds for dehumidification and regeneration as well as for the separation and desorption of carbon dioxide. High temperatures of 100° C. to 250° C. are required to desorb the carbon dioxide from the sorbent and regenerate the drying means. The desorption process is therefore very energy-intensive. The heat distribution in a stationary sorbent bed is rather poor here and all the more difficult the larger the volume of the fixed sorbent bed and the larger the diameter of the sorbent. After desorption of the carbon dioxide and regeneration of the drying means, the respective fixed sorbent beds must be cooled back down to room temperature so that they are available again for dehumidification and separation of carbon dioxide.

One way to reduce the energy consumption and improve the heat distribution is to separate carbon dioxide using moving beds or fluidized beds. This means that the processes of dehumidification and regeneration as well as the separation and desorption of carbon dioxide are not carried out one after the other with stationary sorbent beds and alternating heating and cooling processes, but the sorbents change locations and are guided through the zones where the stationary processes of dehumidification and regeneration and separation and desorption of carbon dioxide take place. The temperatures in the zones are therefore kept constant and the sorbent is supplied to and discharged from the zones. This option for separating carbon dioxide by means of moving sorbent is also known as a moving bed or fluidized bed.

In addition, ceramic-based sorbents such as zeolites are known, which are available as bulk material, particularly in spherical or pellet form, and have a high carbon dioxide storage capacity. The disadvantage of a zeolite material, however,: that it is unsuitable for use in a moving sorbent bed, as the movement causes friction between the zeolite beads or zeolite pellets or a housing surrounding the zeolite beads or zeolite pellets, which leads to severe abrasion. Zeolites have therefore only been used in stationary sorbent beds to date.

### SUMMARY

A need exists to improve the energy efficiency of a system for separating carbon dioxide from the ambient air. The need is addressed by the subject matter of the independent claim(s). Embodiments of the invention are described in the dependent claims, the following description, and the drawings.

### BRIEF DESCRIPTION OF THE DRAWINGS

FIG. 1 shows a schematic representation of a first example embodiment of a system for separating carbon dioxide from the ambient air;

FIG. 2 shows a schematic representation of an example dehumidification unit for such a system;

FIG. 3 shows a schematic representation of a further example system for separating carbon dioxide from the ambient air;

FIG. 4 shows a schematic representation of a further example dehumidification unit for such a system;

FIG. 5 shows a schematic representation of an example carbon dioxide separation unit for such a system; and

FIG. 6 shows a schematic representation of an example embodiment of a system for separating carbon dioxide from the ambient air.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a system for separating carbon dioxide from the ambient air is provided. The system comprises a dehumidification unit for dehumidifying a gas flow of ambient air and a carbon dioxide separation unit connected downstream of the dehumidification unit in the direction of flow of a gas flow through the system. The carbon dioxide separation unit has an adsorption chamber and a desorption chamber that is different from the adsorption chamber. A sorbent is arranged in the carbon dioxide separation unit. The carbon dioxide separation unit comprises a transport means with which the sorbent can be transported from the adsorption chamber into the desorption chamber after absorbing carbon dioxide from a gas flow dried by the dehumidification unit and/or from the desorption chamber into the adsorption chamber after desorption of the carbon dioxide from the sorbent.

Ambient air refers here to the atmospheric air in the vicinity of the carbon dioxide separation system. A dehumidification unit is to be understood as any portion of such a system that is suitable for reducing the degree of moisture and, in particular, for reducing the humidity to less than 20%, or for example less than 10%, or for example less than 5%. In this context, a carbon dioxide separation unit is to be understood as a system component that reduces the carbon dioxide content in the ambient air. An adsorption chamber is to be understood as a process space in which carbon dioxide from the ambient air is bound in a sorbent. A desorption chamber is to be understood as a process space in which the carbon dioxide bound in the sorbent is released again and the sorbent material is regenerated.

Such a system provides process control in which a process space does not have to be heated and cooled alternately for adsorption and subsequent desorption, but only the sorbent has to be transported from the adsorption chamber to the desorption chamber after binding the carbon dioxide. The adsorption chamber and the desorption chamber can each be kept at constant temperatures. This can massively improve the energy efficiency of the system. Furthermore, the system according to the teachings herein provides carbon dioxide to be continuously separated directly from dry atmospheric air by means of fluidizing sorbent material and concentrated carbon dioxide or a gas flow enriched with carbon dioxide to be continuously obtained without generating abrasion on the sorbent material. If humid atmospheric air is present, this system can be used to continuously dehumidify atmospheric air by means of fluidizing drying means and to generate a dry gas flow.

The features listed in the dependent claims describe beneficial developments of the system/method mentioned in the independent claim(s) for separating carbon dioxide from the ambient air.

In some embodiments, it is provided that the dehumidification unit has a first chamber for drying a gas flow with a drying means and a second chamber, which is different from the first chamber, for regenerating the drying means, and with a transport means which is configured to transport the drying means from the first chamber into the second chamber and/or from the second chamber into the first chamber. A dehumidification unit with a first chamber for drying the air flow and a second chamber for regenerating the drying means can increase the energy efficiency of the dehumidification system, as there is no need to alternately heat up and cool down the dehumidification unit. Furthermore, continuous drying of the air flow can be achieved as a result, which means that the process can be better adapted to the continuous carbon dioxide capture process. In this context, a drying means is to be understood as a substance that removes moisture from the ambient air and stores it.

In some embodiments, the dehumidification unit comprises a first dehumidification path and a second dehumidification path, which is different from the first dehumidification path, each dehumidification path having at least one storage container for the drying means, a dehumidification zone for absorbing moisture from the ambient air in the drying means, a regeneration zone for regenerating the drying means and a collection container for receiving the regenerated drying means. Furthermore, in the dehumidification unit, a transport means is provided, with which the drying means can be transported, after passing through one dehumidification path, into the storage container of the respective other dehumidification path. Such a dehumidification unit enables particularly efficient drying of the gas flow supplied to the carbon dioxide separation unit.

In some embodiments, it is provided that a heating element for heating the desorption chamber and a negative pressure source are arranged on and an inlet for a pressure equalizing gas is formed on the desorption chamber. A negative pressure source can accelerate the desorption process and improve the expulsion of carbon dioxide from the sorbent.

According to some embodiments, it is provided that the sorbent is formed as a powdered zeolite and the adsorption chamber and/or the desorption chamber are formed as a fluidized bed. On the one hand, a powdered zeolite enables a particularly high reactive surface area, which enables particularly efficient separation of carbon dioxide from the ambient air. Furthermore, a powdered zeolite, in particular primary zeolite crystals, means that the sorbent is no longer crushed further by friction and retains its shape during the process. This prevents sorbent material from being lost or changing its properties during the process.

In some embodiments, it is provided that the carbon dioxide separation unit has a first carbon dioxide separation path and a second carbon dioxide separation path, wherein each carbon dioxide separation path has at least one storage container for the sorbent, a carbon dioxide absorption zone in which the sorbent binds carbon dioxide from the dried gas flow, and a desorption zone in which the carbon dioxide bound in the sorbent is released again. A carbon dioxide separation unit with two separation paths enables particularly simple and efficient separation of carbon dioxide from the ambient air. In particular if the adsorption chamber and the desorption chamber are designed as a fluidized bed, particularly efficient separation of carbon dioxide from the ambient air and subsequent release of the carbon dioxide bound in the sorbent can be achieved.

In some embodiments, the carbon dioxide absorption zone is arranged geodetically higher than the desorption zone in such a way that the sorbent is transported by gravity from the carbon dioxide absorption zone into the desorption zone when a valve, in particular a ball valve, arranged between the carbon dioxide absorption zone and the desorption zone is opened. This means that the powdered sorbent material can be conveyed from the adsorption chamber to the desorption chamber without additional transport or conveying means. This makes the process even more energy-efficient and easy to control.

In some embodiments, it is provided that a transport means is provided which is configured to transport the sorbent, after it has exited the desorption zone of one carbon dioxide separation path, into the storage container of the respective other carbon dioxide separation path. A powdered sorbent material, in particular a powdered zeolite, can be easily conveyed through the carbon dioxide separation unit by a transport means.

In some embodiments, the transport means is a pneumatic transport path with a conveyor blower, a screw conveyor or a conveyor belt. A pneumatic transport path is a particularly simple and cost-effective way of conveying the sorbent material within the carbon dioxide separation unit. A screw conveyor or a conveyor belt are also suitable for transporting the sorbent material in a simple manner.

A further aspect of the disclosure relates to a method for separating carbon dioxide from the ambient air, using a system described in the preceding sections, which comprises the following method steps:
Drying an air flow of ambient air by means of a drying means in the dehumidification unit
Supplying the dried gas flow from the dehumidification unit to the adsorption chamber of the carbon dioxide separation unit, wherein
the carbon dioxide in the adsorption chamber is bound in a sorbent, and wherein the sorbent is transported from the adsorption chamber into the desorption chamber in order to release the carbon dioxide bound in the sorbent.

Such a method enables process control in which a process space does not have to be heated and cooled alternately for adsorption and subsequent desorption, but only the sorbent has to be transported from the adsorption chamber to the desorption chamber after binding the carbon dioxide. The adsorption chamber and the desorption chamber can each be kept at constant temperatures. This can massively improve the energy efficiency of the system. Furthermore, the method enables carbon dioxide to be continuously separated directly from dry atmospheric air by means of fluidizing sorbent material and concentrated carbon dioxide or a gas flow enriched with carbon dioxide to be continuously obtained without generating abrasion on the sorbent material. If humid atmospheric air is present, the method can be used to continuously dehumidify atmospheric air by means of fluidizing drying means and to generate a dry gas flow.

Reference will now be made to the drawings in which the various elements of embodiments will be given numerical designations and in which further embodiments will be discussed.

The various embodiments of the disclosure mentioned in this application can be combined with one another, unless designed otherwise in individual cases.

Specific references to components, process steps, and other elements are not intended to be limiting. Further, it is understood that like parts bear the same or similar reference numerals when referring to alternate FIGS.

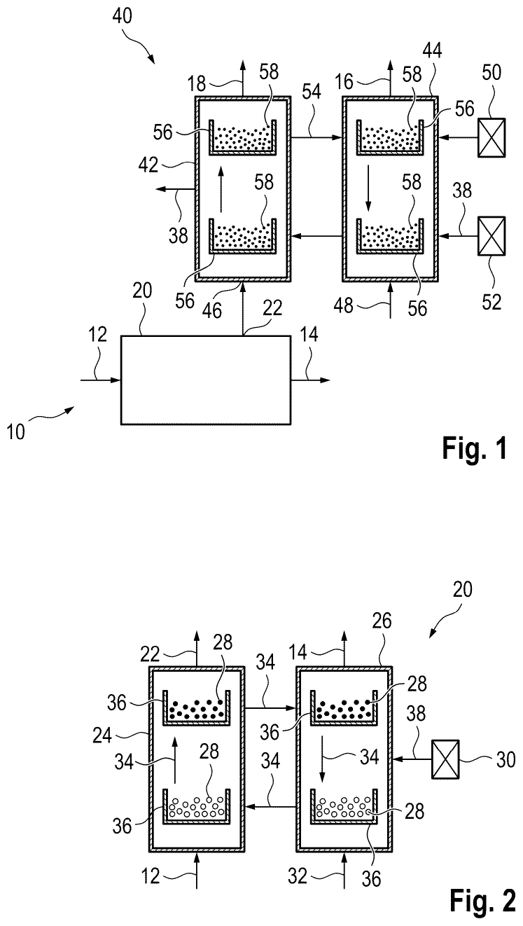

FIG. 1 Shows a Schematic Representation of a System 10 for separating carbon dioxide from the ambient air. The system 10 comprises a dehumidification unit 20 and a carbon dioxide separation unit 40 connected downstream of the dehumidification unit 20 in the direction of flow of a gas flow through the system 10. The dehumidification unit 20 is for example designed as a dehumidification unit 20 shown in FIG. 2 for continuous or quasi-continuous drying of ambient air. Alternatively, the dehumidification unit 20 can also be designed as a discontinuously operating dehumidification unit 20, which dries a quantity of air and then supplies the dried quantity of air to the carbon dioxide separation unit 40. The dehumidification unit 20 has an inlet 12 for ambient air, an outlet 14 for a humid gas flow and an outlet 22 for dried ambient air. The dried ambient air 22 is supplied to the carbon dioxide separation unit 40. In the dehumidification unit 20, water is separated from the ambient air by means of a drying means 28, resulting in a dry gas flow. Silica gel, for example, can be used as the drying means 28. Alternatively, other drying means 28 which are suitable for use in a fluidized process are substantially abrasion-resistant and absorb moisture from the ambient air are also conceivable.

The separation of carbon dioxide from the ambient air takes place in a carbon dioxide separation unit 40. The carbon dioxide separation unit 40 comprises an adsorption chamber 42 and a desorption chamber 44. To separate carbon dioxide from the ambient air, the dry gas flow from the dehumidification unit 20 is conducted at an inlet 46 into an adsorption chamber 42 of the carbon dioxide separation unit 40. The adsorption chamber 42 contains a sorbent 58, which physically and/or chemically separates carbon dioxide from the dry gas flow. A zeolite 60, in particular in the form of zeolite primary crystals, is for example used as the sorbent 58 for separating carbon dioxide from the ambient air. The sorbent 58 is therefore in powder form and can in particular be stored in a container 56. The size of the zeolite primary crystals is in the nm to μm range, for example in the range of 100 nm to 100 μm. The separation takes place by adsorption of carbon dioxide on the sorbent 58. Dehumidification of the atmospheric air is absolutely essential as a preliminary stage for carbon dioxide separation with a zeolite 60 if the ambient air contains moisture. In most cases, it can be assumed that the ambient air contains a certain percentage of water. Due to the pronounced hydrophilicity of zeolite 60, the ambient air must be dehumidified before the separation of carbon dioxide. Otherwise, zeolite 60 mainly binds water molecules instead of carbon dioxide. The adsorption chamber 42 has an outlet 18 for substantially carbon dioxide-free air. The adsorption chamber 42 can also be connected to a cooling device, in particular to a heat exchanger, in order to cool heated sorbent material 58 back down and to feed the heat 38 as process heat back into the system 10 for separating carbon dioxide from the ambient air at a suitable point.

After the absorption of carbon dioxide, the sorbent material 58 is transported out of the adsorption chamber 42 into the desorption chamber 44 by a transport device 54. The desorption chamber 44 has a negative pressure source 50 with which the pressure in the desorption chamber 44 can be lowered compared to the ambient pressure. The negative pressure source is for example designed as a negative pressure pump 97, 117, or rather as a vacuum pump. Furthermore, a heating element 52 is arranged on the desorption chamber 44 and can supply heat 38 to the desorption chamber 44 in order to heat the desorption chamber 44 to a temperature of 100° C. to 250° C. At the temperature of 100° C. to 250° C. and the negative pressure, the carbon dioxide desorbs from the sorbent 58 and can be discharged from the desorption chamber 44 at an outlet 16. Furthermore, the desorption chamber 44 has an inlet 48 for a pressure equalizing gas in order to raise the pressure level back to ambient pressure after a corresponding evacuation. After the desorption process, the sorbent material 58 freed of the carbon dioxide is transported from the desorption chamber 44 into the adsorption chamber 42, again by the transport device 54, where it is again available for binding carbon dioxide.

The process of separating carbon dioxide from the ambient air takes place here continuously or quasi-continuously, wherein the sorbent material circulates continuously between the adsorption chamber 42 and the desorption chamber 44.

FIG. 2 schematically shows an example dehumidification unit 20 for a system 10 for separating carbon dioxide from the ambient air. The ambient air is dehumidified using a drying means 28 in a first chamber 24 of the dehumidification unit 20. For this purpose, the ambient air is introduced into the first chamber 24 through the inlet 12, wherein the drying means 28 absorbs and binds the moisture from the ambient air. The dried ambient air is conducted out of the first chamber 24 again at an outlet 22 and supplied to the carbon dioxide separation unit 40. Once the drying means 28 is saturated with water, the water-rich drying means 28 is transported to a second chamber 26 of the dehumidification unit 20 and regenerated there. In the regeneration process step, water is separated from the drying means again by means of a purge gas and high temperature. For this purpose, an inlet 32 for a purge gas is provided on the second chamber 26. Dry compressed air or nitrogen, for example, can be used as the purge gas. An outlet 14 for a moist gas flow 14 is provided on the second chamber 26 in order to discharge the moisture released from the drying means 28. The second chamber 26 is heated by a heating element 30, wherein the temperature in the second chamber 26 is for example constant in the range of 100° C. to 150° C. and heat 38 is for example continuously supplied to the second chamber 26. Once the drying means 28 has been sufficiently freed of water, the now water-free drying means 28 is transported back into the first chamber 24 by a transport means 34, where it can be used again to dehumidify atmospheric air. The special feature of this embodiment is that the operating conditions in the chambers 24, 26, in particular the temperature in the second chamber 26, are constant for the regeneration of the drying means 28, while the drying means 28 is transported back and forth between the chambers 24, 26. As a result, the energy for heating and cooling the corresponding metallic system containers of the chambers 24, 26 can be conserved. The drying means 28 can be stored and/or transported through the dehumidification unit 20, in particular, in containers 36.

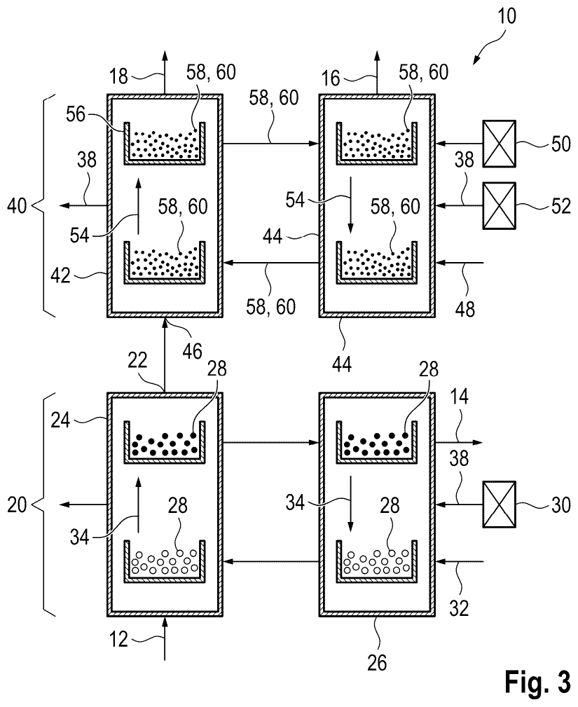

FIG. 3 schematically shows a system 10 for separating carbon dioxide with the dehumidification unit 20 shown in FIG. 2 and the carbon dioxide separation unit 40 shown in FIG. 1. In principle, a process for separating carbon dioxide from the dehumidified ambient air is shown. The carbon dioxide is separated using the sorbent 58 in an adsorption chamber 42 of the carbon dioxide separation unit 40. For this purpose, the dry gas flow coming from the dehumidification unit 20 is introduced into the adsorption chamber 42, wherein the sorbent 58 binds the carbon dioxide. Once the sorbent 58 is saturated with carbon dioxide, this carbon dioxide-rich sorbent 58 is transported into the desorption chamber 44 where it is desorbed of the carbon dioxide. Desorption can take place in two ways. One variant is that carbon dioxide is separated from the sorbent 58 in the desorption chamber 44 by means of negative pressure <100 kPa or vacuum and high temperature. The temperature in the desorption chamber 44 is 100° C. to 250° C. A pressure equalizing gas, for example dry compressed air or nitrogen, is used to restore the ambient pressure following the desorption process. The carbon dioxide separated from the sorbent 58 is conducted out of the desorption chamber 44 and is present in concentrated form. Another variant of the desorption process is that carbon dioxide is separated from the sorbent 58 by means of purge gas and a high temperature of 100° C. to 250° C. The purge gas, in particular dry compressed air or nitrogen, is at the same time the fluidization medium that transports the sorbent 58 through the carbon dioxide separation unit 40. The carbon dioxide separated from the sorbent 58 is conducted out of the desorption chamber 44 together with the purge gas and is present in the gas flow in an enriched form.

Once the sorbent 58 has been completely freed of carbon dioxide, the now carbon dioxide-free sorbent 58 is transported back into the adsorption chamber 42, where it can be used again to separate carbon dioxide from the dehumidified atmospheric air. The special feature of this embodiment is that the operating conditions in the chambers 42, 44, in particular the temperature in the desorption chamber 44, are substantially constant while the sorbent 58 is transported back and forth between the chambers 42, 44. As a result, the energy for heating and cooling the corresponding metallic system containers of the adsorption chamber 42, or rather the desorption chamber 44, can be conserved.

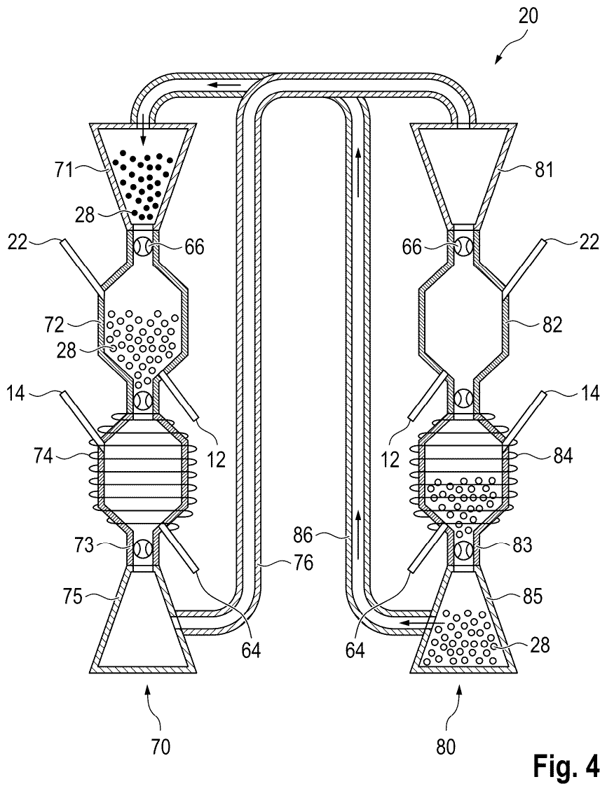

FIG. 4 shows the structure of a dehumidification unit 20 for continuous dehumidification of the ambient air with two dehumidification paths 70, 80. In the first dehumidification path 70, the drying means 28 is present in a storage container 71. Silica gel, for example, can be used as the drying means 28. Via a valve 66, in particular a ball valve, at the bottom of the storage container 71, the drying means 28 trickles into a dehumidification zone 72 to dehumidify the ambient air. Ambient air flows into this dehumidification zone 72 at an inlet 12 via a blower 62. The incoming air causes the drying means 28 to swirl up (fluidize). The dehumidification zone 72 corresponds to a first chamber 24 in FIG. 2 or 3 and is for example designed as a fluidized bed. The particle composition (size, porosity, density) of the drying means 28 must be such that the drying means 28 can fluidize. The drying means 28 should also be abrasion-resistant. An inlet 12 for ambient air and an outlet 22 for a dried gas flow are provided at the dehumidification zone 72.

The flow rate of the incoming ambient air should be regulated so that the drying means 28 can fluidize. When the drying mean 28 is saturated with water, the valve 66, in particular a ball valve, at the bottom of the dehumidification zone 72 is opened and the water-rich drying means 28 trickles into a second chamber 26, which constitutes a regeneration zone 73 for the drying means 28. In the regeneration zone 73, water is separated from the drying means 28 again. The separation of water from the drying means 28 takes place at an elevated temperature. For this purpose, the regeneration zone is heated by a temperature control unit 74. The temperature in the second chamber 26 for regeneration is 100° C. to 150° C. In addition, heated purge gas 64 is for example introduced into the second chamber 26, whereby the drying means 28 is fluidized. The purge gas can be nitrogen or compressed air, for example. The second chamber 26 for removing water from the drying means 28 is for example also a fluidized bed. Once the drying means 28 has been completely freed of water, a valve 66 at the bottom of the second chamber 26 is opened and this now low-water drying means 28 trickles into a first collection container 75. The regenerated, low-water drying means 28 is supplied to the second dehumidification path 80 of the dehumidification unit 20 via a transport path 76, which is designed in particular as a pneumatic transport path 76, screw conveyor or conveyor belt.

The second dehumidification path 80 is constructed in the same way as the first dehumidification path 70 and comprises a storage container 81, a dehumidification zone 82, a regeneration zone 83, a temperature control unit 84 and a collection container 85. Furthermore, a transport path 86 is provided, with which the drying means 28 is fed back into the first dehumidification path 70 after passing through the second dehumidification path 80.

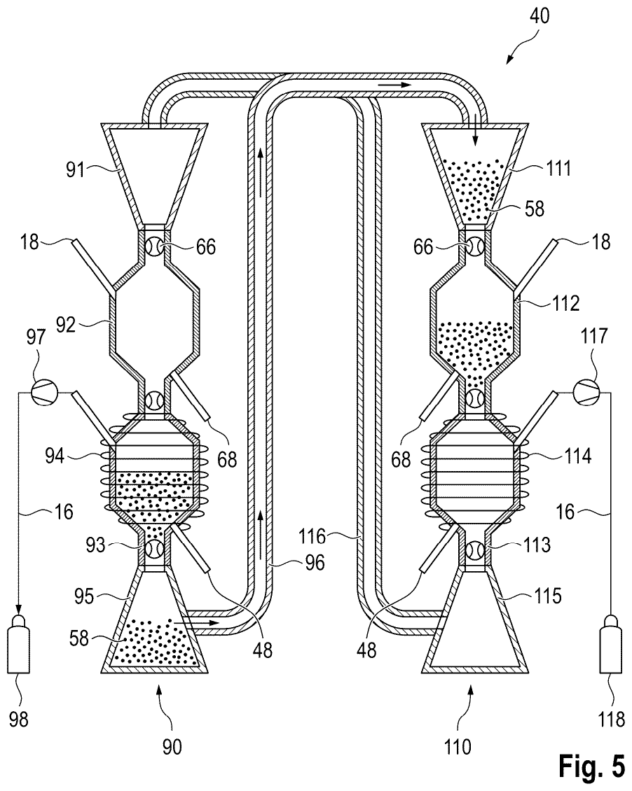

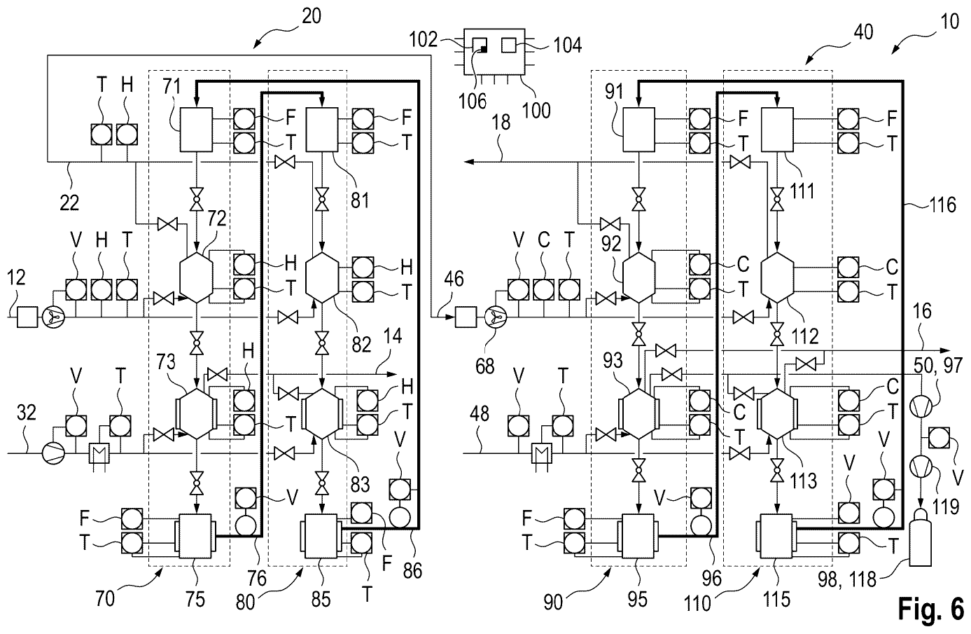

There it is used again to dehumidify ambient air. Ideally, the process times for dehumidifying the ambient air and regenerating the drying means 28 in both paths 70, 80 are set so that atmospheric air is continuously dehumidified and a dry gas flow is generated. FIG. 5 shows a schematic representation of a carbon dioxide separation unit 40 for such a system 10 for separating carbon dioxide from the ambient air. The carbon dioxide separation unit 40 has a first carbon dioxide separation path 90 and a second carbon dioxide separation path 110. In the first carbon dioxide separation path 90, the sorbent 58 is present in the storage container 91. Powdered zeolite is used as the sorbent 58. Via a valve 66, in particular a ball valve, at the bottom of the storage container 91, the sorbent 58 trickles into an adsorption chamber 42, which forms a carbon dioxide absorption zone 92. The carbon dioxide is separated from the dried gas flow from the dehumidification unit 20 and stored in the sorbent. The dried air flows into this adsorption chamber 42 via a blower 68. The supplied dry air flow is simultaneously the fluidizing medium that causes the powdered sorbent 58 to swirl up (fluidize). The absorption chamber 42 is designed as a fluidized bed. The particle composition (size, porosity, density) of the sorbent 58 must be such that the sorbent 58 can fluidize. The Sorbent 58 must also be substantially abrasion-resistant. The flow rate of the incoming dry air is regulated so that the sorbent 58 can fluidize. When the sorbent 58 is saturated with carbon dioxide, a valve 66 at the bottom of the adsorption chamber 42 is opened and the carbon dioxide-rich sorbent 58 trickles into a desorption chamber 44, which forms a desorption zone 93. In the desorption zone 93, the carbon dioxide is separated from the sorbent 58 again. The separation of carbon dioxide from the sorbent 58 takes place at an elevated temperature. The desorption zone 93 is heated by a temperature control unit 94. The temperature in the desorption zone is 100° C. to 250° C. To support desorption, a negative pressure of for example <100 kPa is generated in the desorption zone 93 by means of a negative pressure pump 97. A pressure equalizing gas is introduced into the desorption chamber 44 to restore the atmospheric pressure. The pressure equalizing gas can be nitrogen gas or compressed air. The desorption chamber 44 is designed as a fluidized bed. In this embodiment, the carbon dioxide separated from the sorbent 58 is present in concentrated form and is conducted out of the desorption zone 93 through an outlet 16, compressed by a compressor 119 shown in FIG. 6, and collected in a capture device 98. Once the sorbent 58 has been completely freed of carbon dioxide, a valve 66 at the bottom of the desorption chamber 44 is opened and this now carbon dioxide-free sorbent 58 trickles into a collection container 95. The carbon dioxide-free sorbent 58 is supplied to the second carbon dioxide separation path 110 via a transport path 96, in particular via a pneumatic transport path, a screw conveyor or a conveyor belt. There it is used again to separate carbon dioxide from the dry gas flow. Ideally, the process times for the separation of carbon dioxide and the desorption of carbon dioxide in both paths 90, 100 are set so that carbon dioxide is continuously separated from the dry gas flow and concentrated carbon dioxide is generated.

The second carbon dioxide separation path 110 is for example constructed in the same way as the first carbon dioxide separation path 90 and comprises a storage container 111, a carbon dioxide absorption zone 112, a desorption zone 113, a temperature control unit 114 for the desorption zone, a collection container 115, a negative pressure pump 117 and a capture device 118 for carbon dioxide. Furthermore, a transport path 116 is provided which connects the collection container 115 of the second carbon dioxide separation path 110 to the storage container 91 of the first carbon dioxide separation path 90.

FIG. 6 shows a schematic representation of a system 10 for separating carbon dioxide 10 from the ambient air with a dehumidification unit 20 with a first dehumidification path 70 and a second dehumidification path 80 and a carbon dioxide separation unit 40 with a first carbon dioxide separation path 90 and a second carbon dioxide separation path 110. The system 10 further comprises a control device 100 with a memory unit 102 and a computing unit 104 as well as a computer program code 106 stored in the memory unit 106. In this case, when the computer program code 106 is executed by the computing unit 104, a method according to the teachings herein for separating carbon dioxide from the ambient air is carried out.

In contrast to known solutions, where the sorbent 58 is macroscopically present in spherical or granular form, powdered sorbent material 58 is used in the teachings herein. Ceramic-based sorbents 58, more precisely primary zeolite crystals, that are not embedded in a matrix are for example used. The size of the zeolite crystals is in the nm to μm range, for example 100 nm to 100 μm. The benefit of powdered zeolite 60 is the mechanical stability due to the primary particle size in the nm to μm range. It can be assumed that very small primary particles (diameter 100 nm to 100 μm) show no abrasion during fluidization. Experience from the surface coating of silicon oxide, graphite and transition metal oxide particles (diameter 0.5-50 μm) by means of fluidized bed reactors confirms this assumption.

The sorbent 58 present in powder form has the benefit, compared to spherical or pellet sorbents, of absorbing and releasing the carbon dioxide very quickly, which significantly shortens the process step of separating carbon dioxide from the ambient air. The heat released during the absorption of carbon dioxide can be dissipated quickly due to the very good heat distribution of fluidizing powdery material. Dry compressed air or nitrogen can be used as the fluidizing medium and pressure equalizing gas. The process of carbon dioxide desorption can be supported by applying a negative pressure or vacuum. The fluidization of the powdered sorbent 58 can take place at any pressure below 100 kPa as long as the pressure drop across the sorbent bed is sufficient to maintain the fluidization of the sorbent 58.

### LIST OF REFERENCE NUMERALS

10 System for separating carbon dioxide from the ambient air
12 Inlet for ambient air
14 Outlet for humid gas flow
16 Outlet for carbon dioxide
18 Outlet for carbon dioxide-reduced ambient air
20 Dehumidification unit
22 Outlet for dried gas flow
24 First chamber
26 Second chamber
28 Drying agent
30 Heating element
32 Purge gas inlet
34 Transport means
36 Container
38 Heat
40 Carbon dioxide separation unit
42 Adsorption chamber
44 Desorption chamber
46 Inlet for dried gas flow
48 Pressure equalizing gas inlet
50 Negative pressure source
52 Heating element
54 Transport means
56 Container
58 Sorbent/sorbent material
60 Zeolite
62 Blower
64 Heated purge gas
66 Valve
68 Dried gas flow blower
70 First dehumidification path
71 Storage container
72 First dehumidification zone
73 First regeneration zone
74 First regeneration zone temperature control unit
75 First collection container
76 First pneumatic transport path
80 Second dehumidification path
81 Storage container
82 Second dehumidification zone
83 Second regeneration zone
84 Second regeneration zone temperature control unit
85 Second collection container
86 Second pneumatic transport path
90 First carbon dioxide separation path
91 Storage container
92 First carbon dioxide absorption zone
93 First desorption zone
94 First desorption zone temperature control
95 First collection container
96 First pneumatic transport path
97 First negative pressure pump
98 First capture device for carbon dioxide
100 Control device
102 Memory unit
104 Computing unit
106 Computer program code
110 Second carbon dioxide separation path
111 Storage container
112 Second carbon dioxide absorption zone
113 Second desorption zone
114 Second desorption zone temperature control
115 Second collection container
116 Second pneumatic transport path
117 Second negative pressure pump
118 Second capture device for carbon dioxide
119 Compressor

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A system for separating carbon dioxide from the ambient air, comprising a dehumidifier for dehumidifying a gas flow and a carbon dioxide separation unit connected downstream of the dehumidifier in the direction of flow of a gas flow through the system, wherein the carbon dioxide separation unit has an adsorption chamber and a desorption chamber that is different from the adsorption chamber, wherein a sorbent is arranged in the carbon dioxide separation unit, and wherein the carbon dioxide separation unit comprises a transport device with which the sorbent can be transported from the adsorption chamber into the desorption chamber after absorbing carbon dioxide from a gas flow dried by the dehumidifier and/or from the desorption chamber into the adsorption chamber after desorption of the carbon dioxide from the sorbent.

12. The system for separating carbon dioxide from the ambient air of claim 11, wherein the dehumidifier has a first chamber for drying a gas flow with a drying agent and a second chamber, which is different from the first chamber, for regenerating the drying agent, and with a transport device which is configured to transport the drying agent from the first chamber into the second chamber and/or from the second chamber into the first chamber.

13. The system for separating carbon dioxide of claim 12, wherein the dehumidifier comprises a first dehumidification path and a second dehumidification path, wherein each dehumidification path having at least one storage container for the drying agent, a dehumidification zone for absorbing moisture from the ambient air in the drying agent, a regeneration zone for regenerating the drying agent and a collection container for receiving the regenerated drying agent, and wherein a transport device is provided, with which the drying agent can be transported, after passing through one dehumidification path, into the storage container of the respective other dehumidification path.

14. The system for separating carbon dioxide from the ambient air of claim 11, wherein a heating element for heating the desorption chamber and a negative pressure source are arranged on and an inlet for a pressure equalizing gas is formed on the desorption chamber.

15. The system for separating carbon dioxide of claim 11, wherein the sorbent is formed as a powdered zeolite and the adsorption chamber and/or the desorption chamber are formed as a fluidized bed.

16. The system for separating carbon dioxide from the ambient air of claim 11, wherein the carbon dioxide separation unit comprises a first carbon dioxide separation path and a second carbon dioxide separation path, wherein each carbon dioxide separation path has at least one storage container for the sorbent, a carbon dioxide absorption zone in which the sorbent binds carbon dioxide from the dried gas flow, and a desorption zone in which the carbon dioxide bound in the sorbent is released again.

17. The system for separating carbon dioxide from the ambient air of claim 16, wherein the carbon dioxide absorption zone is arranged geodetically higher than the desorption zone in such a way that the sorbent is transported by gravity from the carbon dioxide absorption zone into the desorption zone when a valve arranged between the carbon dioxide absorption zone and the desorption zone is opened.

18. The system for separating carbon dioxide from the ambient air of claim 16, further comprising a transport device which is configured to transport the sorbent, after it has exited the desorption zone of one carbon dioxide separation path, into the storage container of the respective other carbon dioxide separation path.

19. The system for separating carbon dioxide from the ambient air of claim 18, wherein the transport device is a pneumatic transport path with a conveying blower, a screw conveyor or a conveyor belt.

20. A method for separating carbon dioxide from ambient air with a system,:
drying an air flow of ambient air using a drying agent in a dehumidifier;
supplying a dried gas flow from the dehumidifier into an adsorption chamber of a carbon dioxide separation unit; wherein the carbon dioxide in the adsorption chamber is bound in a sorbent; and wherein
the sorbent is transported from the adsorption chamber into a desorption chamber in order to release the carbon dioxide bound in the sorbent.

21. The method of claim 20, wherein the dehumidifier has a first chamber for drying a gas flow with a drying agent and a second chamber, which is different from the first chamber, for regenerating the drying agent, and with a transport device which is configured to transport the drying agent from the first chamber into the second chamber and/or from the second chamber into the first chamber.

22. The method of claim 21, wherein the dehumidifier comprises a first dehumidification path and a second dehumidification path, wherein each dehumidification path having at least one storage container for the drying agent, a dehumidification zone for absorbing moisture from the ambient air in the drying agent, a regeneration zone for regenerating the drying agent and a collection container for receiving the regenerated drying agent, and wherein a transport device is provided, with which the drying agent can be transported, after passing through one dehumidification path, into the storage container of the respective other dehumidification path.

23. The method of claim 20, wherein a heating element for heating the desorption chamber and a negative pressure source are arranged on and an inlet for a pressure equalizing gas is formed on the desorption chamber.

24. The method of claim 20, wherein the sorbent is formed as a powdered zeolite and the adsorption chamber and/or the desorption chamber are formed as a fluidized bed.

25. The method of claim 20, wherein the carbon dioxide separation unit comprises a first carbon dioxide separation path and a second carbon dioxide separation path, wherein each carbon dioxide separation path has at least one storage container for the sorbent, a carbon dioxide absorption zone in which the sorbent binds carbon dioxide from the dried gas flow, and a desorption zone in which the carbon dioxide bound in the sorbent is released again.

26. The method of claim 25, wherein the carbon dioxide absorption zone is arranged geodetically higher than the desorption zone in such a way that the sorbent is transported by gravity from the carbon dioxide absorption zone into the desorption zone when a valve arranged between the carbon dioxide absorption zone and the desorption zone is opened.

27. The method of claim 25, further comprising a transport device which is configured to transport the sorbent, after it has exited the desorption zone of one carbon dioxide separation path, into the storage container of the respective other carbon dioxide separation path.

28. The method of claim 277, wherein the transport device is a pneumatic transport path with a conveying blower, a screw conveyor or a conveyor belt.
